(19) United States
(12) Patent Application Publication
(10) Pub. No.: US 2024/0365809 A1
(43) Pub. Date: Nov. 7, 2024

(54) STABILIZED FROZEN DESSERTS

(71) Applicant: Michael Foods, Inc., Minnetonka, MN (US)

(72) Inventor: Siquan Li, Gaylord, MN (US)

(21) Appl. No.: 18/646,733

(22) Filed: Apr. 25, 2024

Related U.S. Application Data
(60) Provisional application No. 63/462,757, filed on Apr. 28, 2023.

(51) Int. Cl. A23G 9/32; A23G 9/38; A23G 9/40

(52) U.S. Cl. CPC A23G 9/327; A23G 9/38; A23G 9/40; A23G 2200/10; A23G 2200/12

(57) ABSTRACT

The present disclosure relates to frozen dessert products that include enzyme-hydrolyzed egg yolk. Other primary ingredients include one or more fats and one or more sweeteners. The dessert products exhibit a slower melting rate and a remarkably superior mouthfeel and other sensory attributes.

### CROSS REFERENCE TO RELATED APPLICATIONS

This application claims priority to U.S. Provisional Application Ser. No. 63/462,757, filed Apr. 28, 2023, which is incorporated by reference herein in its entirety.

### TECHNICAL FIELD

The present disclosure relates to dessert products. More specifically, the present disclosure relates to frozen dessert products including enzyme-modified egg yolk that reduces the rate of crystallization and improved microstructures for improved mouthfeel and offer increased shelf life.

### BACKGROUND

Frozen dessert products typically include multiple phases, e.g., solid, aqueous, and air. The solid phase sometimes includes ice crystals and crystals of other water-soluble compounds. The aqueous phase is sometimes super-saturated with water, sugar, hydrocolloids, milk solids, and other soluble components. This multiphasic characteristic of frozen desserts, which is the basis for their food appeal to consumers, presents manufacturers and distributors with difficulties in maintaining food quality.

During transportation and storage after production, frozen dessert products can experience numerous temperature fluctuations. These temperature fluctuations can disrupt the relatively fragile multiphase balance of frozen desserts. In particular, when the temperature rises higher than the freezing point of a frozen dessert, where the freezing point is a function of the concentration of solids in the aqueous phase of the dessert, ice crystals and crystals of other water-soluble compounds can melt, resulting in increased water migration within the product. When the temperature subsequently decreases, typically slowly due to the insulating effects of the ice shell built up around the product, the melted water migrates to and refreezes on the surface of existing crystals, thereby increasing the size of the ice crystals. These larger crystals can adversely affect product quality by producing a sandy, harsh, or rough mouthfeel, non-homogenous product texture, altered flavor or taste, or a combination thereof. Fluctuations in storage temperature can also lead to meltdown, which can disrupt the solid, liquid, and air balance of the product and negatively affect texture. While temperature fluctuation accelerates the process, crystal growth in frozen desserts during frozen storage is an inevitable and ongoing process that results in sandy and rough mouthfeel of the products, which is not desired by consumers. Rate of crystallization is a key factor determining the shelf life of premium frozen dessert products.

To address these issues, a variety of emulsifiers or stabilizers, such as gums, gelatin, fibers, hydrocolloids, starches, and emulsifiers, have been included in frozen dessert product formulations to increase matrix viscosity and control crystal growth so to achieve desired shelf life. These stabilizers also help prevent product drying and shrinkage during storage and distribution. However, use of stabilizers, particularly artificial stabilizers can lead to poor quality of the products and an unpleasant consumption experience due to increased product viscosity or a coating that lingers on the palate after consumption. Use of stabilizers may also not be label friendly and can significantly impact consumer preferences.

### SUMMARY

The present disclosure describes a solution to at least some of the problems associated with current frozen dessert products. The solution resides in incorporation of enzyme-modified egg yolk into frozen dessert product formulations, which can act as an emulsifier to stabilize microstructures during frozen storage of the dessert product. Employing the unique combination of the enzyme-modified egg yolk with further ingredients disclosed herein was found to provide a dessert product that is resistant to melting and that has a remarkably superior mouthfeel. In some aspects, the dessert products retain a superior mouthfeel after frozen storage for at least 10 months. In some aspects, the dessert products include no emulsifiers or stabilizers other than the enzyme-modified egg yolk.

Prior to the present disclosure describing dessert products, such as frozen dessert products (e.g., ice cream), including enzyme-modified egg yolk and the improved quality of these products, the effect of introducing a novel enzyme-modified egg yolk ingredient on the complex microstructures of the products and the corresponding effect on sensory properties of the product upon introduction of enzyme-modified egg yolk was unknown. Further, the health and product quality benefits of including enzyme-modified egg yolk in these products was not understood. Unlike mayonnaise and salad dressing, which are highly acidic, most frozen dessert products, including hardened ice creams, lack the proper acidity to inhibit the activity of enzymes used to modify natural egg yolk. Without both minimized levels of enzyme activity and subsequent enzyme inhibition once these levels are achieved, the degree of hydrolysis of phospholipids in the frozen dessert products can be too great. This phospholipase activity can destroy the emulsion and microstructural properties of the frozen dessert products. Furthermore, active enzyme remaining in the frozen dessert product may, after frequent ingestion of the frozen dessert products in large amounts, present a challenge to the GI tract of a consumer. For example, elevated enzyme activity in the duodenum may result in down-regulating pancreatic activity. Therefore, in some aspects, the dessert products disclosed herein include enzyme-modified yolk that is free of residual enzymatic activity.

Accordingly, some aspects of the disclosure are directed to a dessert product including one or more fats, one or more sweeteners, and enzyme-modified egg yolk comprising greater than or equal to 2% (w/w) free fatty acids. In some aspects, the enzyme-modified egg yolk comprises 4-8% (w/w) free fatty acids. In some aspects, the dessert product comprises 0.5 to 18% (w/w) of the one or more fats, 10-28% (w/w) of the one or more sweeteners, and 0.1-5% (w/w) enzyme-modified egg yolk, based on the total weight of the dessert product.

In some aspects, the enzyme-modified egg yolk is a phospholipase-modified egg yolk, a hydrolyzed egg yolk, or a combination thereof. In some aspects, the enzyme-modified egg yolk is an emulsifier configured to stabilize microstructures during frozen storage of the dessert product. In some aspects, the one or more fats comprise whole milk, whip cream, skim milk, condensed milk, evaporated milk, anhydrous milk fat, cream, butter, butterfat, whey, milk solids non-fat, or a combination thereof. In some aspects, the one or more sweeteners comprise sucrose, glucose, dextrose, syrups, artificial sweeteners, or a combination thereof. In some aspects, the dessert product further comprises one or more additives, water, a protein source, or a combination thereof. In some aspects, the dessert product comprises whole milk, cream, sucrose, water, a protein source, and enzyme-modified egg yolk. In some aspects, the dessert product is hard frozen ice cream, soft serve ice cream, frozen yogurt, sorbet, sherbet, or custard.

In some aspects, the dessert product exhibits an overrun of 30-60%. In some aspects, the dessert product exhibits a melt rate after frozen storage that is significantly lower than a melt rate of a dessert product comprising an unmodified egg yolk. In some aspects, the dessert product exhibits a mouthfeel after frozen storage that is significantly improved compared to a mouthfeel of a dessert product comprising an unmodified egg yolk.

In other aspects, the disclosure is directed to a method of producing a dessert product, comprising treating egg yolk with a phospholipase to hydrolyze the egg yolk phospholipids and yield an enzyme-modified egg yolk comprising greater than or equal to 2% (w/w) free fatty acids, and blending into a homogenous liquid one or more fats, one or more sweeteners, and the enzyme-modified egg yolk.

In some aspects, the dessert product comprises 0.5 to 18% (w/w) of the one or more fats, 10-28% (w/w) of the one or more sweeteners, and 0.1-5% (w/w) enzyme-modified egg yolk, based on the total weight of the dessert product. In some aspects, the dessert product is hard frozen ice cream, soft serve ice cream, frozen yogurt, sorbet, sherbet, or custard.

In some aspects, the method further comprises deactivating the phospholipase after the egg yolk comprises greater than or equal to 2% (w/w) free fatty acids to form the enzyme-modified egg yolk comprising greater than or equal to 2% (w/w) free fatty acids. In some aspects, the phospholipase is deactivated after the egg yolk comprises 4-8% (w/w) free fatty acids.

In some aspects, the method further comprises refrigerating the homogenous liquid for at least 8 hours at a temperature of less than or equal to 4.44° C. (40° F.). In some aspects, the method further comprises processing the homogenous liquid using a continuous freezer equipped with a heat exchanger. In some aspects, the method further comprises spray-drying or freezing the enzyme-modified egg yolk prior to blending the enzyme-modified egg yolk into the homogenous liquid. In some aspects, the method further comprises blending one or more additives, a protein source, or a combination thereof into the homogenous liquid. In some aspects, the method further comprises storing the dessert product at less than −18° C. for two or more months.

The claims are not intended to include, and should not be interpreted to include, means plus- or step-plus-function limitations, unless such a limitation is explicitly recited in a given claim using the phrase(s) “means for” or “step for,” respectively.

The phrase “and/or” means “and” or “or.” To illustrate, A, B, and/or C includes: A alone, B alone, C alone, a combination of A and B, a combination of A and C, a combination of B and C, or a combination of A, B, and C. In other words, “and/or” operates as an inclusive or. The use of the term “or” in the claims is used to mean “and/or” unless explicitly indicated to refer to alternatives only or the alternatives are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, the compositions and methods of the present disclosure that “comprise,” “have,” “include” or “contain” one or more elements possesses those one or more elements, but are not limited to possessing only those one or more elements. Likewise, an element of a composition or method of the present disclosure that “comprises,” “has,” “includes” or “contains” one or more features possesses those one or more features, but is not limited to possessing only those one or more features.

Any embodiment of the compositions and methods of the present disclosure can consist of or consist essentially of—rather than comprise/include/contain/have-any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Compositions and methods “consisting essentially of” any of the elements or steps disclosed limits the scope of the claim to the specified materials or steps which do not materially affect the basic and novel characteristic of the claimed disclosure. The words “consisting of” (and any form of consisting of, such as “consist of” and “consists of”) means including, and limited to, whatever follows the phrase “consisting of.” Thus, the phrase “consisting of” indicates that the listed elements are required or mandatory, and that no other elements may be present.

As used herein, in the specification, “a” or “an” may mean one or more, unless clearly indicated otherwise. As used herein, in the claim(s), when used in conjunction with the word “comprising,” the words “a” or “an” may mean one or more than one. As used herein “another” may mean at least a second or more.

In any disclosed aspect, the terms “about” and “approximately” and “substantially” and the like may be substituted with “within [a percentage] of” what is specified. In one non-limiting aspect, the percentage includes 0.1, 0.5, 1, 5, and 10 percent.

As used herein, unless the surrounding text explicitly indicates a contrary intention, all values given in the form of percentages are weight per weight (w/w), weight percent, or wt. %, corresponding to the proportion of a particular substance within a mixture, as measured by weight or mass.

As used herein, pH values are those which can be obtained from any of a variety of potentiometric techniques employing a properly calibrated electrode.

It is specifically contemplated that any limitation discussed with respect to one embodiment of the disclosure may apply to any other embodiment of the disclosure. Furthermore, any composition of the disclosure may be used in any method of the disclosure, and any method of the disclosure may be used to produce or to utilize any composition of the disclosure.

Other objects, features, and advantages of the present disclosure will become apparent from the following detailed description. It should be understood, however, that the detailed description and the examples, while indicating specific aspects of the disclosure, are given by way of illustration only. Additionally, it is contemplated that changes and modifications within the spirit and scope of the disclosure will become apparent to those skilled in the art from this detailed description.

### BRIEF DESCRIPTION OF THE DRAWINGS

Various features and advantageous details are explained more fully with reference to the non-limiting aspects illustrated in the accompanying drawings and detailed in the following description. It should be understood, however, that the detailed description and the specific examples, while indicating aspects of the disclosure, are given by way of illustration only, and not by way of limitation. Various substitutions, modifications, additions, and/or rearrangements will become apparent to those of ordinary skill in the art from this disclosure.

FIG. 1 is a diagram outlining exemplary method steps employed in a first method for production of a dessert product as disclosed herein.

FIG. 2 is a diagram outlining exemplary method steps employed in a second method for production of a dessert product as disclosed herein.

FIGS. 3A-3B show microstructures of control samples including unmodified egg yolk and test samples including enzyme-modified egg yolk after hardening for 7 days (FIG. 3A) or 8 months (FIG. 3B) as measured using cryogenic electron microscopy.

### DETAILED DESCRIPTION

As noted above, the present disclosure describes dessert products, such as frozen or chilled dessert products (e.g., ice cream), that include enzyme-modified egg yolk. In some aspects, inclusion of enzyme-modified egg yolk in dessert product formulations minimizes the crystallization rates of soluble compounds such as water, salts, sugar, and lactose within the dessert products. In some aspects, dessert products formulated with enzyme-modified egg yolk provide advantages over conventional dessert products formulated with unmodified egg yolk. Such advantages can include, for example: improved overall quality, particularly microstructural and/or textural quality and mouthfeel, to yield creamier, fuller, and better taste due to enhanced flavor releasing properties; longer product shelf life due to the extended length of time the products demonstrate improved microstructural and/or textural quality and mouthfeel; reduced product loss due to increased shelf life, which allows more products to be sold at the end of shelf life; and a higher profit margin for premium products having an improved microstructural and/or textural quality and mouthfeel.

### I. Enzyme-Modified Egg Yolk

Described herein are dessert products including enzyme-modified egg yolk. Also described are methods for making dessert products including enzyme-modified egg yolk. In some aspects, enzyme-modified egg yolk acts as an emulsifier to promote the suspension of lipids in the aqueous phase of the dessert products. In some aspects, enzyme-modified egg yolk stabilizes microstructures during frozen storage of the dessert products. Accordingly, in some aspects, the combination of enzyme-modified egg yolk with further ingredients disclosed herein can provide a dessert product with advantageous properties (e.g., resistance to melting, improved mouthfeel compared to traditional dessert products having unmodified egg yolk). The egg yolk of the enzyme-modified egg yolk may be referred to as egg yolk matter, egg yolk material, or an egg yolk composition, and may include less than (i.e., a portion of), equal to, or greater than (i.e., more than one or portions of more than one) one egg yolk that is enzyme-modified as described herein.

Eggs are used as and in a variety of food ingredients and products. Egg ingredients for production traditionally have been in the form of whole (shell) eggs. However, alternatives to whole (shell) eggs include liquid and dried or powder egg products. In some aspects, liquid and dried or powder egg products can be treated with enzymes to improve their functionality and uses.

Egg white, also known as albumen, is the clear, alkaline liquid portion of the egg surrounding the egg yolk. Egg white constitutes roughly two-thirds of a chicken egg by weight. Egg white includes 10-12% (w/w) protein as well as trace amounts of minerals, fats, vitamins, and carbohydrates carried in water. Slightly more than half of the protein content of eggs is contained in the egg white.

Egg yolk includes a complex oil-water emulsion of about 50% water, 30-35% lipids and 15-20% protein. Egg yolk can include 25-30% phospholipids, which in some aspects, are useful in the manufacture of enzyme-modified egg yolk and finished goods manufactured therefrom. About 75% of the phospholipids in egg yolk are phosphatidylcholine, with the remaining phospholipids being, in descending order of prevalence, phosphatidylethanolamine, lysophosphatidylcholine, sphingomyelin, lysophosphatidylethanolamine, plasmalogen, and inositol phospholipid. The protein profile in egg yolk includes 65-70% low density lipoprotein (lipo-vitellin), 10-15% high density lipoprotein, 10-15% livetins, and 5-10% phosvitin. The majority of egg yolk proteins and lipids/phospholipids (i.e., greater than 50%) form lipoprotein complexes and micelles.

Due to the presence of various lipid and protein types in egg yolk, in some aspects, egg yolk has useful emulsifying properties. In some aspects, egg yolk can act as a natural emulsifier between fat and aqueous phases of a frozen dessert product. Without wishing to be bound by theory, in some aspects, the emulsification activity of egg yolk is derived from its ability to reduce the surface energy between polar and non-polar components of the dessert product, which can make egg yolk useful in recipes for frozen dessert products. For example, egg yolk contains surface-active components that include both hydrophobic and hydrophilic domains. These surface-active components can, in some aspects, stabilize an emulsion by forming an interfacial layer of water around the emulsion droplets. Such a water layer can provide kinetic stability of the emulsion to prevent migration of water or other polar materials away from the droplets and subsequent crystal growth during freeze-thaw cycles during storage and distribution. Sufficient emulsification, such as that provided in some aspects by egg yolk, is desired in frozen dessert products so as to slow down crystal growth to prevent coarse mouth feel or sandiness after frozen storage and, particularly, after distribution, where temperature fluctuation is likely to occur.

In some aspects, enzyme-modified egg yolk can replace regular egg yolk in frozen dessert products to, e.g., improve the microstructure and corresponding sensory attributes of the dessert products. A method of producing an enzyme-modified egg yolk can include heating raw liquid egg yolk to a temperature of about 57° C. to about 61° C. (e.g., at least, at most, exactly, or between any two of 57, 58, 59, 60, or 61° C.) for a time, t, that varies based on the yolk temperature, Ty, according to Formula (I):

$$t = m ( 6 {5}^{°} C . - Ty ) , \qquad ( I )$$

where m is a constant (54 sec/° C.). The raw liquid egg yolk can have a solids content of about 44% (e.g., at least, at most, exactly, or between any two of 40, 41, 42, 43, 44, 45, 46, 47, 48, 49, or 50%).

According to one non-limiting aspect, the liquid egg yolk can be maintained at about 59° C. for 325 to 335 seconds (e.g., at least, at most, exactly, or between any two of 325, 326, 327, 328, 329, 330, 331, 332, 333, 334, or 335 seconds) and at about 61° C. for 205 to 215 seconds (e.g., at least, at most, exactly, or between any two of 205, 206, 207, 208, 209, 210, 211, 212, 213, 214, or 215 seconds). These temperatures are for a stable yolk temperature, i.e., situations where the yolk temperature is maintained within a narrow temperature range. However, if the yolk temperature varies due to, for example, use of a dynamic heating profile and jacket heating control variation, the amount(s) of time at which the yolk is maintained at elevated temperature(s) can be adjusted, with such a modification being within the ambit of an ordinarily skilled artisan. Thus, by way of example, a yolk temperature might be raised from about 59° C. to about 61° C., or vice versa, over a period of time ranging from, e.g., 225 to 275 seconds (e.g., at least, at most, exactly, or between any two of 225, 230, 235, 240, 245, 250, 255, 260, 265, 270, or 275 seconds). Other time-temperature combinations are contemplated.

In some aspects, after heating raw liquid egg yolk to a temperature of about 57° C. to about 61° C. for a time as specified above, yolk temperature is reduced to about 43° C. to about 54° C. (e.g., at least, at most, exactly, or between any two of 43, 44, 45, 46, 47, 48, 49, 50, 51, 52, 53, or 54° C.). In some aspects, the yolk is cooled (or allowed to cool) to a target temperature of about 43° to about 54° C. In some aspects, the yolk is cooled (or allowed to cool) to a target temperature of about 46° C. to about 52° C. In some aspects, the yolk is cooled (or allowed to cool) to a target temperature of about 48° C. to about 50° C. In some aspects, the yolk is cooled (or allowed to cool) to a target temperature of about 44° C. to about 53° C. In some aspects, the yolk is cooled (or allowed to cool) to a target temperature of about 45° C. to about 52° C. In some aspects, the yolk is cooled (or allowed to cool) to a target temperature of about 47° C. to about 51° C. In some aspects, yolk is actively cooled by using an external device (e.g., a refrigerator or freezer) to enhance heat transfer. In some aspects, yolk is allowed to cool passively by natural conduction, convection, and radiation.

In some aspects, once the yolk temperature is reduced to about 43° C. to about 54° C., an amount of an aqueous solution of a generally recognized as safe (“GRAS”) food grade base (i.e., a food additive that is generally recognized, among qualified experts, as having been adequately shown to be safe under the conditions of its intended use) (e.g., sodium hydroxide, potassium hydroxide) sufficient to provide a caustic (i.e., basic) intermediate having a pH of 7.80 to 8.30 (e.g., at least, at most, exactly, or between any two of 7.80, 7.90, 8.00, 8.10, 8.20, or 8.30 units) is added to the yolk. Typical initial yolk pH prior to any pH adjustment is between pH 6.0-6.5, and yolk solid content is between 43% to 48%. Without wishing to be bound by theory, elevation of yolk temperature prior to pH adjustment to form the caustic intermediate is believed to enhance the susceptibility of the yolk proteins and protein-lipid complexes to subsequent enzymatic reactions and to interaction with other yolk components.

The amount of basic solution needed to achieve a pH of 7.80 to 8.30 varies depending on the initial pH of the yolk and the natural variation of its chemical composition as a biochemical matrix. For example, an aqueous 5N (18% w/w) sodium or potassium hydroxide stock solution can be used at 1.5% to 2.5% (e.g., at least, at most, exactly, or between any two of 1.5%, 1.6%, 1.7%, 1.8%, 1.9%, 2.0%, 2.1%, 2.2%, 2.3%, 2.4%, or 2.5%) weight per yolk weight to adjust yolk pH to pH 8.05±0.25 at 50° C. In some aspects, an aqueous 5N (18% w/w) sodium or potassium hydroxide solution can be used at 1.8% to 2.3% weight per yolk weight to adjust yolk pH to pH 8.05±0.25 at 50° C. In some aspects, an aqueous 5N (18% w/w) sodium or potassium hydroxide solution can be used at 2.0% to 2.2% weight per yolk weight to adjust yolk pH to pH 8.05±0.25 at 50° C. The aqueous stock solution of the food grade base can be obtained at different concentrations, e.g., 5N (18% w/w), 30% (w/w), 45% (w/w), etc., and can be diluted to 1-10%, more specifically 2-8%, and most preferably 3-4% (w/w) prior to addition of the solution to yolk for pH adjustment.

In some aspects, the aqueous solution has a concentration (w/w) prior to addition of the solution to yolk for pH adjustment of about 1% to about 30% (e.g., at least, at most, exactly, or between any two of 1, 5, 10, 15, 20, 25, or 30%) of the GRAS base. In some aspects, the aqueous solution has a concentration (w/w) prior to addition of the solution to yolk for pH adjustment of about 3% to about 15% of the GRAS base. In some aspects, the aqueous solution has a concentration (w/w) prior to addition of the solution to yolk for pH adjustment of about 3% to about 7.5% of the GRAS base. In some aspects, the aqueous solution has a concentration (w/w) prior to addition of the solution to yolk for pH adjustment of about 3% to about 5% of the GRAS base. In some aspects, the aqueous solution of the GRAS base is added to the cooled yolk with appropriate agitation/mixing to avoid localized pH shock resulting in yolk protein denaturation and gelling.

In some aspects, an enzyme (i.e., a food grade quality and regulatorily approved enzyme) can be added to the caustic intermediate. The temperature of the resulting mixture can be maintained at a temperature of from about 46° C. to about 52° C. (e.g., at least, at most, exactly, or between any two of 46, 47, 48, 49, 50, 51, or 52° C.) for about 50 to about 250 minutes (e.g., at least, at most, exactly, or between any two of 50, 60, 70, 80, 90, 100, 110, 120, 130, 140, 150, 160, 170, 180, 190, 200, 210, 220, 230, 240, or 250 minutes) to produce an enzyme-modified egg yolk. The enzyme can be obtained in liquid or dry form. If the enzyme is dried, in some aspects, the enzyme is rehydrated in an excess of water (e.g., purified, deionized, distilled), e.g., at a ratio of from 1:2 to 1:10, e.g., from 1:2, 1:3, 1:4, 1:5, 1:6, 1:7, 1:8, 1:9, or 1:10, from 1:3 to 1:9, from 1:4 to 1:8, or from 1:5 to 1:7.

Liquid enzyme or enzyme solution prepared from dried enzyme is added to the pH-adjusted yolk, with sufficient agitation to permit dispersion throughout the entirety of the container in which the pH-adjusted yolk is held. In some aspects, during mixing, addition or incorporation of air to the yolk can be minimized. Relative to the amount of egg yolk, the weight percentage of the enzyme added ranges from 0.0125% to 0.0175% (e.g., at least, at most, exactly, or between any two of 0.0125%, 0.0130%, 0.0135%, 0.0140%, 0.0145%, 0.0150%, 0.0155%, 0.0160%, 0.0165%, 0.0170%, or 0.0175%). In some aspects, 0.0130% to 0.0170% (w/w) enzyme (relative to yolk weight) is added. In some aspects, 0.0140% to 0.0160% (w/w) enzyme (relative to yolk weight) is added.

The enzyme may or may not be kosher and halal approved and certified and can be from different origins (e.g., animal and microbial). Exemplary enzymes include Phospholipase A1 (PLA1) and A2 (PLA2). In some aspects, the enzyme is PLA1. In some aspects, the enzyme is PLA2. In some aspects, the enzyme is specifically designed for food applications and catalyzes hydrolysis of the fatty acid in the second position of phospholipids or lecithin. PLA2 splits the fatty acid in position two of phospholipids, hydrolyzing the bond between the second fatty acid tail and the glycerol backbone. PLA2 is specific for the sn-2 acyl bond of phospholipids and catalytically hydrolyzes phospholipids exclusively at the 2-position, giving rise to the formation of 1-acyl-3-sn-lysophospholipids and free fatty acids. In some aspects, PLA2 can be supplied by Nagase Chemtex Corporation under the trade name Nagase PLA2 10P/R. Nagase PLA2 P/R is produced via fermentation by Streptomyces violacerubar, harvested, and dried into powder having an activity of 100,000 U/g that can, in some aspects, be inactivated at about 70° C.

Hydrolysis of the yolk by the enzyme is performed at a temperature of from about 46° C. to about 52° C. (e.g., at least, at most, exactly, or between any two of 46, 47, 48, 49, 50, 51, or 52° C.). In some aspects, hydrolysis is performed at a temperature of from about 47° C. to about 50° C. In some aspects, hydrolysis is performed at a temperature of from about 48° C. to about 50° C. The length of the permitted hydrolysis reaction can depend on the catalysis temperature employed, with exemplary ranges being 25 to 460 minutes (e.g., at least, at most, exactly, or between any two of 25, 40, 55, 70, 85, 100, 115, 130, 145, 160, 175, 190, 205, 220, 235, 250, 265, 280, 295, 310, 325, 340, 355, 370, 385, 400, 415, 430, 445, or 460 minutes. In some aspects, hydrolysis is performed for 75 to 400 minutes. In some aspects, hydrolysis is performed for 50 to 225 minutes. In some aspects, hydrolysis is performed for 75 to 200 minutes. In some aspects, hydrolysis is performed for more typically 100 to 175 minutes. In some aspects, hydrolysis is performed for 150 minutes±10% (e.g., at least, at most, exactly, or between any two of 135, 140, 145, 150, 155, 160, or 165 minutes).

During enzymatic modification of egg yolks, phospholipids are converted into free fatty acids and stable lysophospholipids (“LPLs”) to produce enzyme-modified (i.e., phospholipase-modified or hydrolyzed) egg yolk. Non-limiting examples of LPLs include lysophosphatidylcholine, lysophosphatidylethanolamine and lysophosphatidaylserine lysophosphatidic acid (radyl-lyso-glycerophosphate, LPA), 2,3-cyclic phosphatidic acid, 1-alkyl-2-acetyl-glycero-3-phosphate, sphingosine-1-phosphate (SIP), dihydro-sphingosine-1-phosphate, sphingosylphosphorylcholine (lysosphingomyelin, SPC), and lysophosphatidylcholine (LPC). Conversion of phospholipids to LPLs results in hydrolysis of the egg yolk. Without wishing to be bound by theory, in some aspects, LPLs can provide enhanced emulsification relative to their phospholipid precursors due to increased hydrophilicity and molecular flexibility. The increased hydrophilicity and molecular flexibility of LPLs compared to phospholipid precursors can inhibit breakage of emulsions (either oil-in-water or water-in-oil) that causes oil(s) to separate, fat globule flocculation, rupture of air cells (such as those comprising frozen dessert product microstructures) and form large clusters. LPLs also tend to be more stable at or when exposed to elevated temperatures, e.g., greater than about 90° C. Accordingly, in some aspects, LPLs generated from the enzymatic modification of egg yolk can, for example, permit high temperature pasteurization/retort to improve microbiological safety and product shelf life.

Monitoring of the yolk pH and free fatty acid concentration can help to determine the degree of yolk hydrolysis, which can vary somewhat based on the desired product functionality. In the industry, a common way to indicate degree of hydrolysis is by measuring the amount of free fatty acid. Fatty acids liberated through enzymatically-catalyzed hydrolysis of the yolk phospholipids are converted to free fatty acid, and the total amount of free fatty acids is measured to determine the degree of yolk hydrolysis. The amount of free fatty acid in powdered enzyme-modified egg yolk does not differ significantly from the amount in liquid enzyme-modified egg yolk. Although the degree of yolk hydrolysis may be measured and reported herein according to the total amount of free fatty acids in the yolk, the degree of yolk hydrolysis may also be reported by converting and presenting the amount of free fatty acids as a percentage of oleic acid, as is customary in the industry. Accordingly, in any of the aspects disclosed herein, the free fatty acids of the enzyme-modified egg yolk can be measured in oleic acid equivalents. Oleic acid is an abundant and important unsaturated fatty acid with well documented nutritional significance.

Non-enzyme treated (i.e., unmodified) yolk usually has a free fatty acid of from about 0.7% to about 1.8% (w/w), varying based on breed, feed, and growth conditions. In some aspects, prior to final (full) pasteurization, the enzyme-modified egg yolk produced according to the methods described herein includes a free fatty acid content of from about 2% to about 15% (w/w) (e.g., at least, at most, exactly, or between any two of 1.0%, 2.5%, 5%, 7.5%, 10%, 12.5%, or 15%). In some aspects, enzyme-modified egg yolk produced includes a free fatty acid content of from about 4% to about 10% (w/w). In some aspects, enzyme-modified egg yolk produced includes a free fatty acid content of from about 4% to about 8% (w/w). In some aspects, enzyme-modified egg yolk produced includes a free fatty acid content of from about 5% to about 7% (w/w).

In some aspects, hydrolysis by the enzyme (e.g., a phospholipase) (e.g., phospholipase A2) proceeds until the egg yolk comprises greater than or equal to 2% (w/w) free fatty acids to provide an enzyme-modified egg yolk having greater than or equal to 2% (w/w) free fatty acids. In some aspects, the enzyme (e.g., a phospholipase) (e.g., phospholipase A2) is deactivated by a heat treatment. In some aspects, the heat treatment is performed in combination with a pasteurization step. In some aspects, the heat treatment is performed after the egg yolk reaches the targeted degree of phospholipid hydrolysis and/or comprises the targeted amount of free fatty acids. In some aspects, the targeted amount of free fatty acids in the yolk is greater than or equal to 2% (w/w) free fatty acids. In some aspects, the enzyme (e.g., a phospholipase) (e.g., phospholipase A2) is deactivated after the egg yolk comprises a free fatty acid content of from about 2% to about 15% (w/w) (e.g., at least, at most, exactly, or between any two of 1.0%, 2.5%, 5%, 7.5%, 10%, 12.5%, or 15%). In some aspects, the enzyme (e.g., a phospholipase) (e.g., phospholipase A2) is deactivated after the egg yolk comprises a free fatty acid content of from about 4% to about 10% (w/w). In some aspects, the enzyme (e.g., a phospholipase) (e.g., phospholipase A2) is deactivated after the egg yolk comprises a free fatty acid content of from about 4% to about 8% (w/w). In some aspects, the enzyme (e.g., a phospholipase) (e.g., phospholipase A2) is deactivated after the egg yolk comprises a free fatty acid content of from about 5% to about 7% (w/w).

The pH of the enzyme-modified egg yolk (without neutralization), measured at about 49° C. to about 51° C., generally ranges from about 6.7 to about 7.3 (e.g., at least, at most, exactly, or between any two of 6.7, 6.8, 6.9, 7, 7.1, 7.2, or 7.3). In some aspects, the pH of the enzyme-modified egg yolk (without neutralization), measured at about 49° C. to about 51° C., is about 6.8 to about 7.2. In some aspects, the pH of the enzyme-modified egg yolk (without neutralization), measured at about 49° C. to about 51° C., is about 6.9 to about 7.2. In some aspects, the pH of the enzyme-modified egg yolk (without neutralization), measured at about 49° C. to about 51° C., is about 7.0 to about 7.2.

Optionally, the method of producing an enzyme-modified egg yolk described herein can include pasteurizing the enzyme-modified egg yolk, spray drying the enzyme-modified egg yolk so as to yield a powder version of the enzyme-modified egg yolk, and/or freezing the enzyme-modified egg yolk so as to yield a frozen version of the enzyme-modified egg yolk.

The enzyme-modified (e.g., hydrolyzed) egg yolk can be pasteurized by maintaining the yolk at a temperature of from about 66° C. to about 75° C. (e.g., at least, at most, exactly, or between any two of 66, 67, 68, 69, 70, 71, 72, 73, 74, or 75° C.) for a specified amount of time. In some aspects, the enzyme-modified (e.g., hydrolyzed) egg yolk can be pasteurized by maintaining the yolk at a temperature of from about 66° C. to about 72° C. In some aspects, the enzyme-modified (e.g., hydrolyzed) egg yolk can be pasteurized by maintaining the yolk at a temperature of from about 68° C. to about 72° C. In some aspects, the enzyme-modified (e.g., hydrolyzed) egg yolk can be pasteurized by maintaining the yolk at a temperature of from about 69° C. to about 71° C. In some aspects, these temperatures have been found to be sufficient to deactivate enzyme (e.g., phospholipase) (e.g., phospholipase A2) activity and/or eliminate pathogenic microorganisms of concern to promote product safety and shelf stability.

The length of time at which the enzyme-modified (e.g., hydrolyzed) egg yolk is maintained at a specific temperature or temperature range for pasteurization depends on the particular temperature(s) employed for pasteurization but generally ranges from about 150 to about 600 seconds (e.g., at least, at most, exactly, or between any two of 150, 200, 250, 300, 350, 400, 450, 500, 550, or 600 seconds). In some aspects, the enzyme-modified (e.g., hydrolyzed) egg yolk is maintained at a specific temperature or temperature range for pasteurization for about 400 to about 480 seconds. In some aspects, the enzyme-modified (e.g., hydrolyzed) egg yolk is maintained at a specific temperature or temperature range for pasteurization for about 410 to about 475 seconds. In some aspects, the enzyme-modified (e.g., hydrolyzed) egg yolk is maintained at a specific temperature or temperature range for pasteurization for about 250 to about 470 seconds. In some aspects, the enzyme-modified (e.g., hydrolyzed) egg yolk is maintained at a specific temperature or temperature range for pasteurization for about 420 to about 465 seconds. In one aspect, an exemplary time/temperature combination for pasteurization of the enzyme-modified (e.g., hydrolyzed) egg yolk is about 69° C. to about 71° C. for about 400 seconds to about 500 seconds. In one aspect, an exemplary time/temperature combination for pasteurization of the enzyme-modified (e.g., hydrolyzed) egg yolk is about 70° C. for about 450 seconds. In some aspects, pasteurized enzyme-modified (e.g., hydrolyzed) egg yolk is mixed with fresh unmodified egg yolk at 1:9 ratio (pasteurized enzyme-modified yolk to fresh unmodified egg yolk) and incubated at, e.g., 69° C. to about 71° C. for about 150 min to confirm enzyme deactivation. In some aspects, pasteurization completely inactivates the enzyme, and no increase in free fatty acid content is observed. Accordingly, in some aspects, the dessert products disclosed herein include enzyme-modified yolk that is free of residual enzymatic (e.g., phospholipase) (e.g., phospholipase A2) activity.

In some aspects, the enzyme-modified egg yolk, whether pasteurized or unpasteurized, is cooled below 5° C. In some aspects, the enzyme-modified egg yolk, whether pasteurized or unpasteurized, is cooled to about 0° C. to about 4.5° C. (e.g., at least, at most, exactly, or between any two of 0, 0.5, 1, 1.5, 2, 2.5, 3, 3.5, 4, or 4.5° C.). The cooled enzyme-modified egg yolk can be stored at refrigerator or freezer temperatures if the cooled enzyme-modified egg yolk is to be used in liquid form. Alternatively, the cooled enzyme-modified egg yolk liquid can be spray dried so as to provide a powdered cooled enzyme-modified egg yolk.

The foregoing methods can produce an enzyme-modified (e.g., phospholipase-modified or hydrolyzed) egg yolk product that, when used to make a frozen dessert product, can act as an emulsifier to provide dessert products with improved stability, melt resistance, and shelf life compared to dessert products produced with conventional, unmodified egg yolk. Without wishing to be bound by theory, hydrolysis of the position 2 ester bond between the glycol backbone and the fatty acid of phospholipids can result in improved polarity and flexibility of the resultant isophospholipids, thereby producing a molecule that is more prone to binding with both polar molecules and the non-polar molecules. In some embodiments, the improved intra-molecular flexibility of isophospholipids makes the enzyme-modified egg yolk included in the dessert products more tolerant to high energy motions such as those caused by elevated temperature and mechanical shearing. Accordingly, in some aspects, enzyme-modified egg yolk advantageously has improved emulsifying properties in the egg yolk itself, as well as an ability to stabilize otherwise incompatible ingredients in the emulsion, including when subjected to physical stresses compared to dessert products including unmodified egg yolk. Therefore, in some aspects, the enzyme-modified egg yolk provides significantly enhanced dessert products having an improved melt rate and mouth feel characterized by, for example, improved smoothness, creaminess, viscosity, and palate coating, without changing the product ingredients and/or processing.

### II. Dessert Products

Disclosed herein, in some aspects, are dessert products including enzyme-modified egg yolk. In some aspects, inclusion of enzyme-modified egg yolk in the dessert products can provide dessert products that are superior to conventional dessert products formulated with unmodified egg yolk. For example, dessert products formulated with enzyme-modified egg yolk can have improved overall quality, particularly microstructural and/or textural quality and mouthfeel compared to conventional dessert products formulated with unmodified egg yolk. Inclusion of enzyme-modified egg yolk in the dessert products can yield creamier, fuller, and better tasting dessert products due to improved crystal stability during frozen storage and/or enhanced flavor releasing properties provided, at least in part, by the enzyme-modified egg yolk. Dessert products formulated with enzyme-modified egg yolk can also have a longer product shelf life than conventional dessert products formulated with unmodified egg yolk due to the significantly slower growth rate of crystals of water soluble components, thereby improving the microstructural quality to provide a smoother and fuller mouthfeel. This can reduce product loss and allow more products to be sold for a significantly longer period of shelf life without significant exhibition of a sandy or rough mouthfeel, which is considered to be a major quality default for frozen dessert products (e.g., ice cream). Premium dessert products formulated with enzyme-modified egg yolk having improved microstructural and/or textural quality and mouthfeel may also yield a higher profit margin compared to conventional dessert products formulated with unmodified egg yolk.

In some aspects, the dessert products are frozen dessert products, which are one of the most popular consumer products. Frozen dessert products can include, without limitation, nondairy-based products such as sorbet and water ices, dairy products such as ice cream, ice milk, sherbet, custard, mousse, gelato, frozen yogurt, soft serve ice cream, and milk shakes, and specialty items such as bars, cones, and sandwiches. In some aspects, the frozen dessert product is ice cream. In some aspects, the frozen dessert product is soft serve ice cream. In some aspects, the frozen dessert product is frozen yogurt. In some aspects, the frozen dessert product is sherbet. In some aspects, the frozen dessert product is custard. In some aspects, the frozen dessert product is sorbet.

The ingredients customarily used in dessert products are fat(s) and sugar/sweetener(s). Non-limiting examples of fat sources that may be included in the dessert products disclosed herein include vegetable fats and/or dairy ingredients, such as whole milk, whip cream, skim milk, condensed milk, evaporated milk, anhydrous milk fat, cream, butter, butterfat, whey (e.g., whey protein concentrate, or “WPC”), milk solids non-fat (“MSNF”), or combinations thereof. WPC can be obtained by removing sufficient non-protein constituents from pasteurized whey by physical separation techniques such as precipitation, filtration, or dialysis to produce a finished dry product containing more than 80% protein. Acidity may be adjusted by the addition of safe and suitable (e.g., GRAS) pH ingredients. WPC includes, by weight, approximately 80-82% protein, 4-8% lactose, and 4-8% fat. MSNF is made up of, by weight, approximately 38% milk protein, 54% lactose, and 8% minerals and vitamins. Non-limiting examples of sweeteners that may be included in the dessert products disclosed herein include sucrose, glucose, dextrose, syrups, artificial sweeteners, or combinations thereof.

In some aspects, ice cream is a frozen dessert with greater than 9% milk fat by weight. An ice cream with greater than 12 to 13% fat may be categorized as a luxury or premium ice cream. In some aspects, soft serve ice cream is a frozen dessert with 4-5% percent milk fat by weight. In some aspects, frozen yogurt is a frozen dessert with 3-6% percent (full fat) or 2-4% (low fat) milk fat by weight. In some aspects, custard is a frozen dessert with at least 10% milk fat and at least about 1.4% egg yolk by weight. In some aspects, milk ice is a frozen dessert with less than 9% milk fat and the same sweetener content as ice cream. In some aspects, sherbets have a milk fat content of between 1% and 2%, MSNF up to about 5 wt %, and slightly higher sweetener content than ice cream. Sherbet is flavored either with fruit or other characterizing ingredients. Sorbet and water ices are similar to sherbets, but contain no dairy ingredients. Mousse contains whipped cream and whipped egg white, and includes a flavoring component, typically chocolate. The formulation and manufacture of these and other frozen desserts is well known to those skilled in the art and is available from many sources. The composition and labeling of many of these products is controlled by governmental regulation, which may vary from country to country.

The fat content of a frozen dessert typically determines the category to which the frozen dessert belongs. For example, general frozen dessert formulations as defined by TETRA PAK® listed in Table 1 below are grouped in descending order of fat content.

TABLE 1
Typical Frozen Dessert Formulations

| | Fat | MSNF | Sugar | E/S | Water | Overrun |
|---|---|---|---|---|---|---|
| Dessert Type | (wt. %) | (wt. %) | (wt. %) | (wt. %) | (wt. %) | (vol. %) |
| Dessert ice | 15 | 10 | 15 | 0.3 | 59.7 | 110 |
| Ice cream | 10 | 11 | 15 | 0.5 | 63.5 | 100 |
| Milk ice | 4 | 12 | 13 | 0.6 | 70.4 | 85 |
| Sherbet | 2 | 4 | 22 | 0.4 | 71.6 | 50 |
| Water ice | 0 | 0 | 22 | 0.2 | 77.8 | 0 |
| Sorbet | 0 | 0 | 22 | 0.5 | 77.5 | 30-50 |

In some aspects, to provide a dessert product with better shelf life and mouthfeel compared to conventional dessert products, a dessert product including enzyme-modified egg yolk is provided. In some aspects, the dessert product delivers an optimal outcome in regard to shelf life, mouthfeel, creaminess, gumminess, mouth/tongue coating, texture, viscosity, sweetness, flavor/taste, hardness/firmness, and melting rate on the tongue of a consumer.

In some aspects, the dessert product includes 0.5-28.0% (w/w) milk fat and/or fat from other sources (w/w) (e.g., at least, at most, exactly, or between any two of 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, or 18% of one or more fats), 10-28% (w/w) (e.g., at least, at most, exactly, or between any two of 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, or 28%) of one or more sweeteners, and 0.1-5% (w/w) (e.g., at least, at most, exactly, or between any two of 0.1%, 0.5%, 1%, 1.5%, 2%, 2.5%, 3%, 3.5%, 4%, 4.5%, or 5%) of egg yolk (i.e., enzyme-modified egg yolk or unmodified egg yolk), based on the total weight of the dessert product. In some aspects, the dessert product further includes 1-15% of milk solids-not-fat (e.g., non-fat dried milk (NFDM)), which contains the lactose, caseins, whey proteins, and minerals (ash content) of the milk product from which they were derived.

In some aspects, the dessert product comprises an overrun, corresponding to the volume of air in the dessert product, ranging from 30-200%. The term “overrun” refers to the volume of air in a food product. Overrun is expressed as the percentage of the volume of air with respect to the volume of a raw material mixture. For example, a dessert product having 100% overrun contains the same volume of air as a mixture of the raw materials of the dessert product. Air is typically incorporated to provide desirable properties. When overrun is properly incorporated, air cells are finely divided and evenly distributed to help provide structure and creaminess. The air cells are dispersed in the liquid portion, which contains the other ingredients of the ice cream. The overrun for ice cream is typically in the range of about 20% to about 250%. In some aspects, the dessert products disclosed herein have a more desirable overrun than a dessert product including an unmodified egg yolk. The overrun of the dessert products disclosed herein can be at least, at most, exactly, or between any two of 20%, 40%, 60%, 80%, 100%, 120%, 140%, 160%, 180%, or 200%. In some aspects, the dessert product exhibits an overrun of 30-60%. In some aspects, the dessert product exhibits an overrun of about 40%. In some aspects, the dessert product exhibits an overrun of about 45%. In some aspects, the dessert product exhibits an overrun of about 50%.

In some aspects, the dessert product has a pH of 6, 7, or 8. In some aspects, the dessert product has a pH of about 7. The presence of particulates such as, e.g., fruit purees, fruit pieces and cuts, and chocolate chips or drops, can expand the pH range of the frozen dessert products. Frozen yogurts and derivatives thereof can have a pH less than pH 4.5, less than pH 4.0, or less than pH 3.6.

The dessert products disclosed herein may also include one or more additional emulsifiers/stabilizers, one or more additives, or combinations thereof. Non-limiting examples of additional emulsifiers/stabilizers that may be included in the dessert products disclosed herein include monoglycerides, locust bean gum, guar gum, xanthan gum, cellulose gum, carrageenan, or combinations thereof. Non-limiting examples of additives that may be included in the dessert products disclosed herein include alternative or additional flavoring and/or coloring agents, vitamins, alternative or additional sweeteners, and acidifying agents.

Many different flavoring agents may be included in the dessert products disclosed herein. The flavoring agents may be natural. Non-limiting examples of flavoring agents include caramel, coffee extract, lemon flavor, mint flavor, chocolate flavor, cocoa, vanilla, vanilla extract, fruit extracts, vegetable extracts, fruit juice, vegetable juice, and combinations thereof. Vitamins may include any of vitamin A, a vitamin A derivative, a vitamin B, a vitamin B derivative, vitamin C, a vitamin C derivative, vitamin D, a vitamin D derivative, vitamin E, a vitamin E derivative, vitamin F, a vitamin F derivative, vitamin K, a vitamin K derivative, thiamine, riboflavin, niacin, vitamin B6, folate, vitamin B12, biotin, and pantothenic acid. Alternative or additional sweeteners may be allulose, erythritol, monk fruit, stevia, and the like.

The dessert products disclosed herein may also include one or more mix-ins. The mix-ins may be natural. Non-limiting examples of mix-ins include brownies, pastries, cookies, cookie dough, chocolate chips, chocolate pieces, chocolate crunch, fudge, chocolate sauce, caramel sauce, peanut butter, marshmallows, marshmallow cream, pretzels, nuts, granola, fruit, candy, sprinkles, and the like. Any combination of these mix-ins may be included in the dessert products disclosed herein.

Any one or more of the foregoing emulsifiers/stabilizers, additives, or combinations thereof may be excluded from the present dessert products. In some aspects, exclusion of one or more of the foregoing emulsifiers/stabilizers, additives, or combinations thereof from the present dessert products does not lower the quality of the dessert products. In some aspects, the dessert products include no emulsifiers or stabilizers other than the enzyme-modified egg yolk. In some aspects, the dessert products from which emulsifiers or stabilizers other than the enzyme-modified egg yolk have been excluded have similar or improved attributes compared to dessert products including additional emulsifiers or stabilizers. Without wishing to be bound by theory, commonly used stabilizers, emulsifiers, and thickeners, e.g., guar gums, locust bean gum, xanthan gum, monoglycerides, diglycerides, polysorbates, sorbitan tristearate, can slow drainage of air cells by increasing air cell wall material viscosity. However, these additional stabilizers, emulsifiers, and thickeners can be eliminated or minimized from the present dessert products, without causing product quality reduction. This may be due to: (1) improved emulsification capability of the enzyme-modified egg yolk, which elevates the incorporation/distribution of air, fat, and other non-polar components across the continuous aqueous matrices; (2) improved efficiency of the enzyme-modified egg yolk in stabilizing the microstructures in frozen desserts; and/or (3) improved molecular flexibility of the yolk lipoproteins in the enzyme modified yolks, which allows lipoproteins containing the lysophospholipids to more easily, and with higher affinity, coat the surfaces of non-polar components, such as milk fat globules. Together, these properties can result in distribution of the non-polar components in smaller sizes (smaller air cells, smaller fat globules, etc.). These properties can also improve stability during subsequent storage and distribution due to slower drainage within the interface and stronger interfacial membranes from the lysophospholipids' high affinity coating.

In some aspects, the dessert product including enzyme-modified egg yolk exhibits a mouthfeel after frozen storage that is significantly improved compared to a mouthfeel of a conventional dessert product comprising unmodified egg yolk. Mouthfeel is a product of organoleptic or sensory quality attributes of the dessert product including crumbliness, gumminess, greasiness, sandiness, melting rate, and melting viscosity and may be assessed subjectively (i.e., by a panel of trained or untrained subjects) or objectively (e.g., by one or more analytic tests). Accordingly, in some aspects, the dessert product including enzyme-modified egg yolk exhibits organoleptic or sensory quality attributes after frozen storage that are improved compared to a conventional dessert product comprising an unmodified egg yolk, where the organoleptic or sensory quality attributes are one or more of crumbliness, gumminess, greasiness, sandiness, melting rate, or melting viscosity. An improvement in one or more organoleptic or sensory quality attributes can refer to a better score for the one or more organoleptic or sensory quality attributes assigned by a panel of trained or untrained subjects for the dessert product including enzyme-modified egg yolk compared to a score for the one or more organoleptic or sensory quality attributes assigned by the panel of trained or untrained subjects for a conventional dessert product comprising unmodified egg yolk. Whether a score assigned for a given organoleptic or sensory quality attribute is better or worse than another score depends on the criteria and desired levels for each of the attribute, as described elsewhere herein. Additionally, or alternatively, an improvement in one or more organoleptic attributes can refer to a better number, value, or score for the one or more organoleptic attributes of the dessert product including enzyme-modified egg yolk as objectively measured by one or more analytic tests compared to a number, value, or score for conventional dessert product comprising unmodified egg yolk as objectively measured by one or more analytic tests.

As used herein, crumbliness refers to shape retention and surface breakage of a shaped portion of the dessert product (e.g., a scooped ball). In some aspects, the dessert products including enzyme-modified egg yolk disclosed herein are less crumbly (i.e., hold their shape better and have less surface breakage of a shaped portion) than a dessert product including an unmodified egg yolk.

As used herein, gumminess refers to the tendency of the dessert product to stick to the teeth and/or palate of a consumer and the resistance to retreat of the dessert product from the teeth and/or palate of a consumer. When tested on a texture analyzer, gumminess is defined as the product of hardness/firmness and cohesiveness, where hardness/firmness is a peak value obtained based on a force-time chart and cohesiveness is the ratio of a second compression curve area divided by area of a first compression curve. When tested by trained sensory panelists and professionals, gumminess is defined by sensory evaluation and using a hedonic scoring system. Panelists rate product samples based on interaction of the samples with their tongue and teeth and based on their individual sensory sensitivity. Panelists are regularly calibrated or anchored using reference dessert products (e.g., commercial frozen ice creams). In some aspects, the dessert products including enzyme-modified egg yolk disclosed herein can be formulated with fewer to no stabilizers (e.g., gums, polysorbate 80) than a dessert product including an unmodified egg yolk. In some aspects, the dessert products including enzyme-modified egg yolk disclosed herein are about as gummy (i.e., similarly inclined to stick to the teeth and/or palate of a consumer and similarly resistant to retreat of the dessert product from the teeth and/or palate of a consumer) than a dessert product including an unmodified egg yolk. However, due to the reduction or elimination of non-label friendly stabilizers and artificial emulsifiers such as gums and polysorbate 80, the overall gumminess of the dessert products including enzyme-modified egg yolk disclosed herein is expected to be less the gumminess of a dessert product including an unmodified egg yolk. Accordingly, in some aspects, the dessert products including enzyme-modified egg yolk disclosed herein are less gummy (i.e., are less inclined to stick to the teeth and/or palate of a consumer and are less resistant to retreat of the dessert product from the teeth and/or palate of a consumer) than a dessert product including unmodified egg yolk.

As used herein, greasiness refers to one of the organoleptic aspects experienced by consumers when a dessert product is consumed. Greasiness typically refers to a slick or oily mouthcoating, and in particular, the experience of a slick or oily coating remaining on the surface of the palate and/or mouth cavity after consuming a sample of a dessert product. In some aspects, the dessert products including enzyme-modified egg yolk disclosed herein are less greasy (i.e., leaves a less slick or oily coating on the surface of the palate and/or mouth cavity of a consumer) than a dessert product including unmodified egg yolk. In some aspects, the dessert products can therefore provide a cleaner-feeling and more enjoyable consumer experience.

As used herein, sandiness refers to coarse mouthfeel of a dessert product due to presence of crystals, e.g., water, sugar, and/or lactose crystals. In some aspects, sandiness is an indicator of crystal growth rate during frozen storage of dessert products. In some aspects, the dessert products including enzyme-modified egg yolk disclosed herein are less sandy (i.e., include fewer solid crystals) than a dessert product including unmodified egg yolk.

As used herein, melting rate (melting quality) refers to the rate at which frozen components (e.g., milk fat, sugar, and ice crystals) in the dessert product melt into the liquid phase from the solid phase, and melt quality refers to the mouthfeel of the dessert product and the release of flavor from the dessert product as it melts. Melting rate can be affected by fat destabilization, ice crystal size, and the consistency coefficient of the base mix. Melting rate can be tested by trained sensory panelists or empirically by melting 100 g of the frozen dessert at a controlled temperature and collecting the amount of drip after a specified amount of time has elapsed (e.g., 10 minutes). In some aspects, when empirically tested, melt rate for a hardened frozen dessert of premium quality can be 0.1 to 1.0 g/min (e.g., at least, at most, exactly, or between any two of 0.1, 0.2, 0.3, 0.4, 0.5, 0.6, 0.7, 0.8, 0.9, or 1.0 g/min), 0.2 to 0.6 g/min, or 0.3 to 0.5 g/min. In some aspects, the dessert products including enzyme-modified egg yolk disclosed herein has a melting rate that matches consumers' expectations, i.e., does not melt so fast as to be considered watery, cheap, and flavorless, and does not melt so slow as to be considered dry, chill, and dull. In some aspects, the dessert products including enzyme-modified egg yolk disclosed herein exhibit an improved melting rate after frozen storage and at consumption compared to a melting rate of a dessert product comprising unmodified egg yolk.

As used herein, the term “viscosity” refers to dynamic viscosity (p), an indication of resistance to flow of a fluid, which is the tangential force per unit area necessary to move one plane past another at unit velocity at unit distance apart. The SI physical unit is the Pascal-second (Pa-s), which equals 1 kg/m-s. The physical unit for dynamic viscosity in the centimeter gram second (cgs) system of units is the poise (P), more commonly expressed, particularly in ASTM standards, as centipoise (cP). In some aspects, the dessert products including enzyme-modified egg yolk disclosed herein have a melt viscosity ranging from 1,000 to 10,000 cPs. In some aspects, the melt viscosity can be at least, at most, exactly, or between any two of 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, or 10000 cPs. In some aspects, the melt viscosity is about 5500 cPs. In some aspects, the dessert products including enzyme-modified egg yolk disclosed herein exhibit a melt viscosity after frozen storage that is higher than a melt rate of a dessert product comprising unmodified egg yolk.

Accordingly, in some aspects, dessert products including enzyme-modified egg yolk in place of regular unmodified egg have an extended shelf life due to maintenance of a smooth and creamy mouth feel desired by consumers after storage at less than about −18° C. to less than about −30° C. (e.g., at least, at most, exactly, or between any two of −18, −20, −22, −24, −26, −28, or −30° C.) for up to one week (e.g., at least, at most, exactly, or between any two of 1, 2, 3, 4, 5, 6, or 7 days), one month (e.g., at least, at most, exactly, or between any two of 1, 2, 3, or 4 weeks), or one year (e.g., 1, 2, 3, 4, 5, 6, 7, 8, 9, 10, 11, or 12 months). In some aspects, even after one year (e.g., up to 20 months), under appropriate storage and handling, dessert products including enzyme-modified egg yolk are acceptable for consumption.

### III. Methods of Preparing Dessert Products

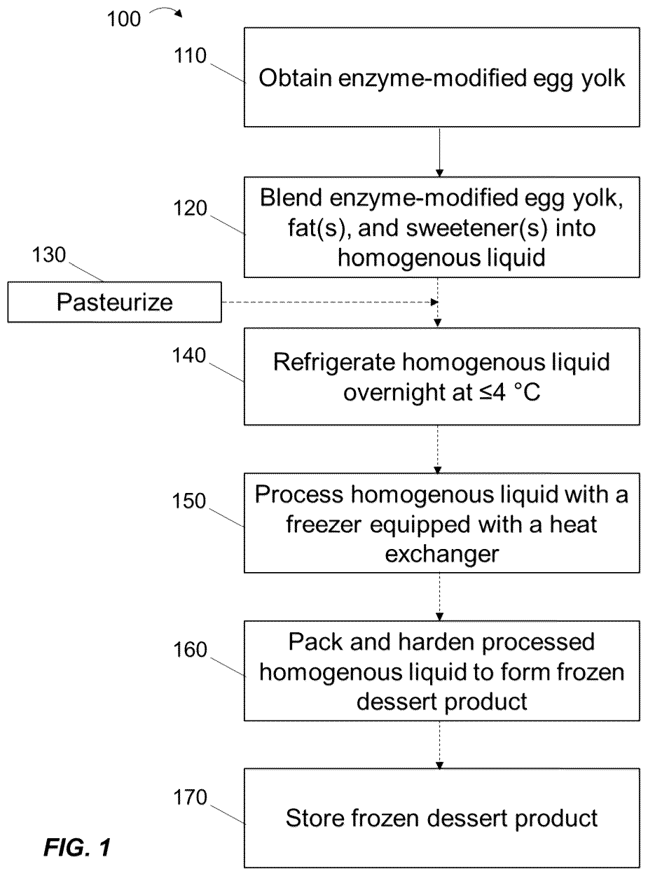

Reference is now made to FIG. 1, which is a simplified flowchart 100 of a first method for producing a dessert product, such as a dessert product (e.g., a hardened ice cream product) including enzyme-modified egg yolk, in accordance with an aspect of the present disclosure. In a first step 110, enzyme-modified egg yolk is obtained as described elsewhere herein. The enzyme-modified egg yolk may be liquid, spray-dried, or frozen. The liquid enzyme-modified egg yolk can be rehydrated enzyme-modified egg yolk powder. In a second step 120, a mixing bowl can be heated (e.g., to about 37-38° C.), and the dessert product ingredients (i.e., liquid, spray-dried, or frozen enzyme-modified egg yolk, one or more fats, one or more sweeteners, etc.), are mixed together in the mixing bowl to form a homogenous liquid. The homogenization step creates a stable, uniform, and consistent mixture.

Optionally, in some aspects, the homogenous liquid can be pasteurized (e.g., by holding at about 88° C. for about 20 seconds) at step 130. In some aspects, pasteurization can be performed by any method known to those of skill in the art, e.g., indirect (tube-in-tube) or direct (steam injection, plates, or scratch surface vat). In some aspects, the liquid dessert product may be homogenized before or after pasteurization, as known to those of skill in the art.

Optionally, in some aspects, the temperature of the homogenous liquid, whether pasteurized or unpasteurized, is brought to a temperature less than or equal to about 4.44° C. (40° F.) in step 140. The homogenous liquid may be maintained at the cooling temperature overnight, e.g., for a period of at least 8 hours. The homogenous liquid may be maintained at the cooling temperature for a period ranging from 8 hours to 24 hours (e.g., at least, at most, exactly, or between any two of 8, 10, 12, 14, 16, 18, 20, 22, or 24 hours). After cooling step 140, the homogenous liquid can be processed (e.g., by a continuous freezer equipped with a scraped surface heat exchanger) at step 150 such that individual fat globules (˜1 μm) begin to form clusters of partially coalesced fat globules of about 10-100 μm. At step 160, the processed homogenous liquid can then be packed into appropriate containers and hardened to a temperature of less than about-18° C. to less than about −30° C. (e.g., at least, at most, exactly, or between any two of −18, −20, −22, −24, −26, −28, or −30° C.) to form a frozen dessert product.

Optionally, at step 170, the frozen dessert product can be stored at less than about-18° C. to less than about −30° C. (e.g., at least, at most, exactly, or between any two of −18, −20, −22, −24, −26, −28, or −30° C.) for up to one week (e.g., at least, at most, exactly, or between any two of 1, 2, 3, 4, 5, 6, or 7 days), one month (e.g., at least, at most, exactly, or between any two of 1, 2, 3, or 4 weeks), or one year (e.g., 1, 2, 3, 4, 5, 6, 7, 8, 9, 10, 11, or 12 months). In some aspects, the frozen dessert product is stored at less than about −18° C. to less than about −30° C. (e.g., at least, at most, exactly, or between any two of −18, −20, −22, −24, −26, −28, or −30° C.) for two or more months. In some aspects, storage of the frozen dessert product including enzyme-modified egg yolk at less than about −18° C. to less than about −30° C. (e.g., at least, at most, exactly, or between any two of −18, −20, −22, −24, −26, −28, or −30° C.) for up to one week (e.g., at least, at most, exactly, or between any two of 1, 2, 3, 4, 5, 6, or 7 days), one month (e.g., at least, at most, exactly, or between any two of 1, 2, 3, or 4 weeks), or one year (e.g., 1, 2, 3, 4, 5, 6, 7, 8, 9, 10, 11, or 12 months) does not negatively impact mouthfeel of the dessert product, i.e., does not negatively impact the crumbliness, gumminess, greasiness, sandiness, melting rate, and/or melting viscosity of the dessert product including the enzyme-modified egg yolk.

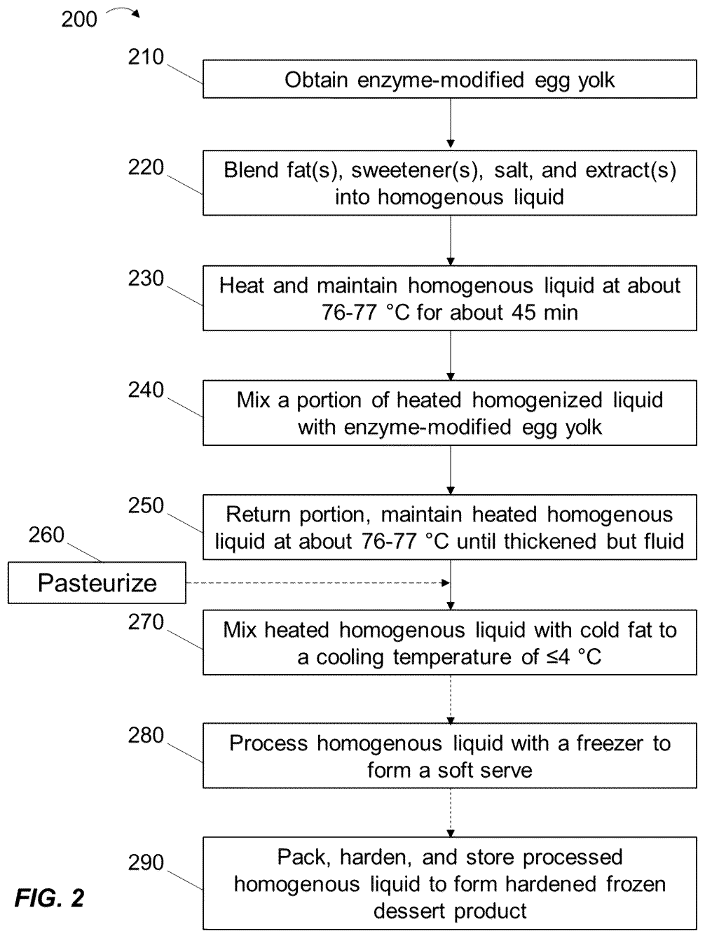

Reference is now made to FIG. 2, which is a simplified flowchart 200 of a second method of producing a dessert product, such as a dessert product (e.g., a soft ice cream product) including enzyme-modified egg yolk, in accordance with an aspect of the present disclosure. In a first step 210, enzyme-modified egg yolk is obtained as described elsewhere herein. The enzyme-modified egg yolk may be liquid, spray-dried, or frozen. The liquid enzyme-modified egg yolk can be rehydrated enzyme-modified egg yolk powder. In a second step 220, dessert product ingredients (i.e., one or more fats, one or more sweeteners, salt, one or more flavoring extracts, etc.) are added to a mixing bowl and mixed together in the mixing bowl to form a homogenous liquid. Next, at step 230, the homogenous liquid is heated to and maintained at about 76-77° C. (e.g., at least, at most, exactly, or between any two of 70, 71, 72, 73, 74, 75, 76, 77, 78, 79, 80, 81, 82, 83, 84, or 85° C.) for about 45 min (e.g., at least, at most, exactly, or between any two of 40, 41, 42, 43, 44, 45, 46, 47, 48, 49, or 50 min). At step 240, a portion of the heated homogenous liquid is removed from the mixing bowl and added to enzyme-modified egg yolk with mixing. Then, at step 250, the portion of the heated homogenous liquid containing the enzyme-modified egg yolk is returned to the mixing bowl, and the mixture is maintained at about 76-77° C. (e.g., at least, at most, exactly, or between any two of 70, 71, 72, 73, 74, 75, 76, 77, 78, 79, 80, 81, 82, 83, 84, or 85° C.) until thickened but still fluid.

Optionally, in some aspects, the homogenous liquid can be pasteurized (e.g., by holding at about 88° C. for about 20 seconds) at step 260. In some aspects, pasteurization can be performed by any method known to those of skill in the art, e.g., indirect (tube-in-tube) or direct (steam injection, plates, or scratch surface vat). In some aspects, the liquid dessert product may be homogenized before or after pasteurization, as known to those of skill in the art.

At step 270, the heated homogenous liquid containing the enzyme-modified egg yolk is poured into a mixing bowl that has been pre-chilled in an ice water bath, the mixing bowl containing a cold fat, such as heavy cream. The homogenous liquid containing the enzyme-modified egg yolk and the cold fat are mixed until homogenous and brought to a temperature less than or equal to about 4.44° C. (40° F.).

Optionally, after step 270, the homogenous liquid can be processed (e.g., by a freezer) (e.g., a Waring WCIC25 2.5 Quarts ice cream machine) at step 280 until frozen to a soft serve consistency. Optionally, at step 290, the processed homogenous liquid can be packed into appropriate containers and hardened to a temperature of less than about −18° C. to less than about −30° C. (e.g., at least, at most, exactly, or between any two of −18, −20, −22, −24, −26, −28, or −30° C.) to form a hardened frozen dessert product. The hardened frozen dessert product can be stored at less than about −18° C. to less than about −30° C. (e.g., at least, at most, exactly, or between any two of −18, −20, −22, −24, −26, −28, or −30° C.) for up to one week (e.g., at least, at most, exactly, or between any two of 1, 2, 3, 4, 5, 6, or 7 days), one month (e.g., at least, at most, exactly, or between any two of 1, 2, 3, or 4 weeks), or one year (e.g., 1, 2, 3, 4, 5, 6, 7, 8, 9, 10, 11, or 12 months). In some aspects, the hardened frozen dessert product is stored at less than about −18° C. to less than about −30° C. (e.g., at least, at most, exactly, or between any two of −18, −20, −22, −24, −26, −28, or −30° C.) for two or more months. In some aspects, storage of the hardened frozen dessert product including enzyme-modified egg yolk at less than about −18° C. to less than about −30° C. (e.g., at least, at most, exactly, or between any two of −18, −20, −22, −24, −26, −28, or −30° C.) for up to one week (e.g., at least, at most, exactly, or between any two of 1, 2, 3, 4, 5, 6, or 7 days), one month (e.g., at least, at most, exactly, or between any two of 1, 2, 3, or 4 weeks), or one year (e.g., 1, 2, 3, 4, 5, 6, 7, 8, 9, 10, 11, or 12 months) does not negatively impact mouthfeel of the hardened frozen dessert product, i.e., does not negatively impact the crumbliness, gumminess, greasiness, sandiness, melting rate, and/or melting viscosity of the hardened frozen dessert product including the enzyme-modified egg yolk.

### EXAMPLES

The following examples are included to demonstrate preferred embodiments of the disclosure. It should be appreciated by those of skill in the art that the techniques disclosed in the following examples represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Hardened Ice Cream Product Formulations

An exemplary dessert product comprising a hardened ice cream according to the present disclosure was prepared for testing. The ingredients used in preparing the test dessert product included whole milk, cream, sugar, water, enzyme-modified egg yolk, and whey protein concentrate. Also prepared was a control dessert product comprising a hardened ice cream lacking enzyme-modified egg yolk powder. The ingredients used in preparing the control dessert product included whole milk, cream, sugar, water, unmodified egg yolk powder, and whey protein concentrate. The ingredients were provided in the amounts indicated below in Table 2.

TABLE 2
Exemplary Hardened Ice Cream Formulations

| | Control Amount | Test Amount |
|---|---|---|
| Ingredient | % (w/w) | % (w/w) |
| Whole milk | 51.35% | 51.35% |
| Heavy cream | 25.60% | 25.60% |
| Sugar | 15.40% | 15.40% |
| Water | 1.90% | 1.90% |
| Unmodified egg yolk powder | 1.40% | — |
| Enzyme-modified egg yolk powder | — | 1.40% |
| Whey protein concentrate (WPC80) | 0.50% | 0.50% |

An exemplary method for preparing dessert products based on the above formulations is summarized in FIG. 1 and is described elsewhere herein. Methods for preparing the test and control dessert products were identical so as to directly determine the influence of the enzyme-modified egg yolk ingredient versus unmodified egg yolk on the resulting dessert product.

### Example 2

### Sensory Evaluation of Hardened Ice Cream Product

The control and test hardened ice cream products of Example 1 were hardened at −24.5° C. for 7 days up to 8 months. Hardened formulations were then used as the day 0 sample for measurement of microstructural properties and organoleptic attributes by a sensory evaluation panel. The panel consisted of 6 trained professionals. Key microstructural properties and organoleptic attributes measured included crumbliness, gumminess, greasiness, sandiness, melting rate, and melt viscosity.

Sensory evaluation results for key organoleptic attributes of the control and test hardened ice cream products as measured at 2, 6, and 8 months after hardening and storage at −24.5° C. are summarized below in Table 3.

TABLE 3
Sensory Results

| | 2-month | | 6-month | | 8-month | | 10-month | |
|---|---|---|---|---|---|---|---|---|
| | Con- | | Con- | | Con- | | Con- | |
| Attribute | trol | Test | trol | Test | trol | Test | trol | Test |
| Crumbliness | 6.91* | 4.21* | 5.46* | 3.15* | 5.45* | 3.28* | 5.75* | 3.31* |
| Gumminess | 5.7 | 5.75 | 5.12 | 5.38 | 5.13 | 5.35 | 5.23 | 5.61 |
| Melt rate | 9.42* | 8.61* | 9.14 | 8.65 | 9.5 | 8.62 | 8.92 | 8.49 |
| Melt viscosity | 5.55 | 6.01 | 6.7 | 6.32 | 6.8 | 6.31 | 6.12 | 6.37 |
| Greasiness | 4.39* | 3.60* | 4.51 | 4.15 | 4.50 | 4.10 | 5.13* | 4.00* |
| Sandiness | 1.62* | 0.86* | 2.40* | 1.27* | 2.37* | 1.43* | 2.11* | 1.27* |

*denotes significant difference between formulations evaluated (p < 0.5)

Sensory quality attributes were rated by trained professional ice cream panelists on a 0-10 scale. The criteria and desired levels for each of the sensory quality attributes were as follows.

Crumbliness. Describes the smoothness of the surface of the frozen dessert. The score given by the panelists is based on the tendency of the surface to crumble, crack, or be rough, i.e., crack on the surface of a scooped ice cream ball. A low to medium score, i.e., 2-4, is desired.

Gumminess. Describes the cohesiveness or “stickiness” of the frozen dessert on the palate. A medium score, i.e., 4-6, is desired. Too high a score suggests that the matrices of the dessert are too sticky and leave behind an unclean palate, while too low a score suggests a less fuller mouthfeel and a cheaper, less luxurious-tasting product.

Melt rate. A measurement of the rate at which the frozen dessert melts, i.e., at body temperature when tested by panelists. A higher score refers to a higher melt rate. A desired score ranges from 6-9. Too high a melt rate suggests that the frozen dessert melts too fast, producing a cooler feel and a burst of flavor release that is short lived. Too low a melt rate suggests a dull texture and lack of flavor burst.

Melt viscosity. Describes the melt liquid viscosity on the palate. A desired score is in the middle of the range, i.e., 3-7. Too low a melt viscosity suggests a watery liquid and mouthfeel, while too high a score suggests a thick, pasty mouthfeel. Within the desired range, a higher score may suggest a fuller mouthfeel.

Greasiness. Describes a greasy mouthfeel on the palate and mouth cavity when consuming a frozen dessert. Slight fatty notes with a creamy feel is desired. A desired score ranges from 1-5. Too high a greasiness score suggests poor emulsion stability and enlarged and aggregated fat (cream) globules. Greasiness tends to increase as storage time increases. Appropriate homogenization helps slow but not stop increased greasiness of a frozen dessert during storage. The presence of large crystals and fast crystal growth rate can accelerate increased greasiness.

Sandiness. Describes a rough or coarse mouthfeel detected by the tongue when consuming a frozen dessert. The sandiness of a frozen dessert is determined primarily by the size of crystals presenting in the dessert matrices. In general, the finer (smaller) the crystals, the less sandy the dessert feels. For premium hardened ice cream, a low sandiness score is desired, i.e., below 2, which suggests that undesired sandiness is not detectable. In sherbet and milk ice or the like, sandiness can be higher due to the presence of large ice crystals.

Day 0 sensory evaluation showed no difference in quality attributes including crumbliness, gumminess, melt rate, melt viscosity, or sandiness. However, use of enzyme-modified egg yolk in place of unmodified egg yolk in the test hardened ice cream product significantly improved (reduced) the crumbliness of the dessert product at 2, 6, and 8 months of hardening and storage at −24.5° C. The surface of scooped ice cream balls from test samples showed a significantly smoother surface structure with noticeably less cracks.

Use of enzyme-modified egg yolk in place of unmodified egg yolk in the test hardened ice cream product also significantly improved (reduced) the sandy or coarse mouthfeel of the product at 2, 6, 8, and 10 months of hardening and storage at −24.5° C. Sandiness tends to worsen during storage and distribution of hardened dessert products. While the sandy mouthfeel of the test hardened ice cream product increased during frozen storage, the rate at which sandiness increased was much lower in the test sample compared to the control hardened ice cream product formulated with unmodified egg yolk according to the same ice cream preparation process. It is also noteworthy that the 2-month test hardened ice cream product exhibited an undetectable (less than 1.0) sandy mouthfeel, while a sandy mouthfeel was already well detectable by trained professional panelists in the control hardened ice cream product having unmodified yolk as the natural emulsifier in the formula. At 6 months' frozen storage, while the control hardened ice cream product already exhibited a noticeable sandy mouthfeel and scored at 2.40, the test hardened ice cream product scored at 1.27, which was detectable by the trained professional panelists by would not be detectable by consumer panelists. Tested after frozen storage for 8 months, the sandy mouthfeel of the test hardened ice cream product was 1.43, which was still well below 2.0. Similar results were obtained after frozen storage for 10 months. While the control hardened ice cream product from ice creams formulated with unmodified egg yolk exhibited sandiness and a coarse mouthfeel and lack of creaminess, the test hardened ice cream product formulated with enzyme-modified egg yolk maintained minimum sandiness and a smooth, creamy texture. Accordingly, hardened ice cream product formulated with enzyme-modified egg yolk is expected to exhibit a longer period of effective shelf life (>12 months) due to stable microstructures (i.e., less crumbly, greasy, or sandy than a control after extended frozen storage).

These results confirm that, in some aspects, use of enzyme-modified egg yolk in place of unmodified yolk in dessert products can significantly improve mouthfeel of a product to provide an improved, or smoother, finer, and creamier, mouthfeel at consumption. Usage of enzyme-modified yolk can also significantly improve crumbliness of hardened dessert products, even deep at the air cell surface levels. Without wishing to be bound by theory, it is believed that these properties are the result of stabilization by the enzyme-modified yolk of microstructures that form upon freezing the dessert products. These findings suggest that the use of enzyme-modified egg yolk in place of unmodified egg yolk in dessert products like ice cream and other frozen dessert products can significantly extend the shelf life of the products and can maintain the premium quality and desired smooth and creamy mouthfeel of the products for at least twice the time of products including unmodified egg yolk. These properties can allow for larger distribution regions of the dessert products.

Test hardened ice cream product samples, made with the enzyme-modified egg yolk, exhibited a higher overrun when measured prior to hardening, than the control hardened ice cream product samples made under the same conditions and using same formulation, with the exception of the egg yolk used in the formulation. The overrun of the control hardened ice cream product prior to packing for freezing on larger pilot scale trial runs samples was 42.3%, while the overrun of the test hardened ice cream product samples was 47.6%. Without wishing to be bound by theory, the significant improvement in overrun in test hardened ice cream product samples including enzyme-modified egg yolk is believed to be due to the increased emulsification capacity of the enzyme-modified egg yolk. This can reduce interfacial tension between the polar phase (e.g., water, sugar) and the non-polar phase (e.g., fat and air) to provide better air cell incorporation into the continuous phase and increase stability during processing of the ice cream. This suggests that, in some aspects, enzyme-modified egg yolk improved the air incorporation volume and resulted in a more desirable overrun.

Measured empirically, the melting rate of ice cream samples made with unmodified yolk was 0.55±0.20 g/min, and the melting rate of test hardened ice cream product made with enzyme-modified yolk was 0.46±0.25 g/min. The slower melting rate of the test hardened ice cream product made with enzyme-modified yolk compared to the control demonstrates that use of enzyme-modified egg yolk in place of unmodified egg yolk can product a desired melting rate even in the absence of other added stabilizers and emulsifiers (e.g., as mono- and di-glycerides).

Measured empirically, after 20-month frozen storage, the melting viscosity of ice cream samples made with unmodified yolk was 5351±12 cPs, while the melt viscosity of the test hardened ice cream product made with enzyme-modified yolk was 5603±12 cPs, when both melt viscosities were measured at 18.2° C. Both showed shear thinning behavior, and viscosity tended to decrease as the temperature at which the samples were measured increased. The higher melt viscosity of the test hardened ice cream product may have resulted from stabilization of microstructures in the ice cream by the enzyme-modified yolk and/or the fine and uniform distribution of air cells and fat globules. The improved emulsification capacity and enhanced cell wall interface viscosity may have prevented air cell and fat globule flocculation and air cell merging, thereby slowing drainage within the interface walls. The increase in melt viscosity also significantly improved the overall mouthfeel of the test hardened ice cream product made with enzyme modified yolk and provided the test samples with a richer and creamier texture and more balanced flavor release behavior compared to the ice cream samples made with unmodified yolk.

The sensory evaluation results aligned with the instrumental melting viscosity measurements. Both confirmed that enzyme-modified yolk, compared to unmodified yolk, improved the melt viscosity of hardened ice creams and improved the overall sensory attributes of the test samples. Both also confirmed that using enzyme-modified yolk can provide more efficient and higher emulsification capability. In other words, using enzyme-modified yolk can allow for replacement of some or all otherwise needed additional emulsifiers (e.g., mono- and di-glycerides, polysorbates, sorbitan tristearate, etc.), without impairing and, in some cases, even improving the quality of, target frozen dessert products. The elimination of non-label friendly artificial emulsifiers such as polysorbates may also help manufacturers establish their frozen dessert pipelines such that more attractive marketing claims can be made (e.g., products can be marketed as premium, all natural, non-artificial, etc.).

### Example 3

### Evaluation of Hardened Ice Cream Product Microstructure

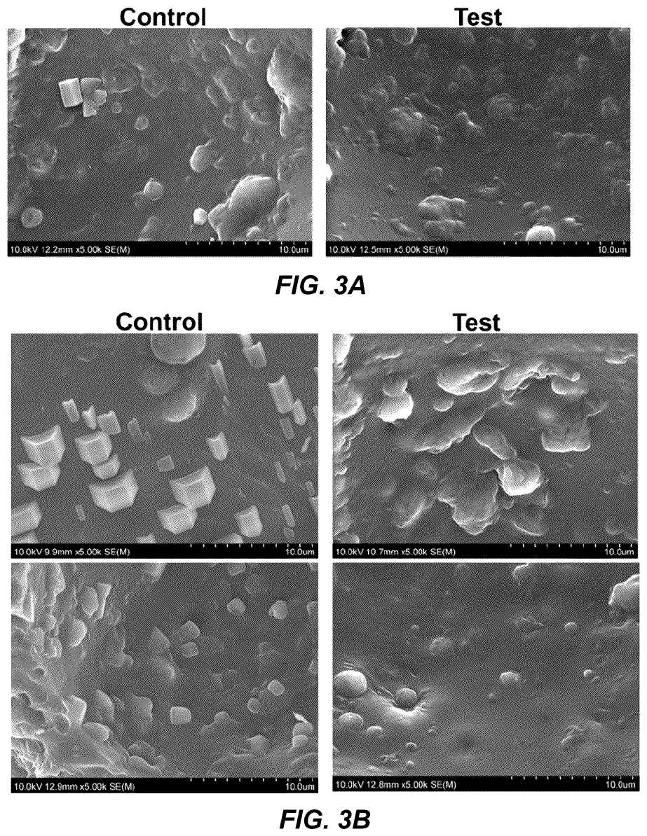

Microstructures of the control and test dessert product formulations of Example 1 were measured using cryogenic scanning electron microscopy (CSEM) at different magnifications. Shown in FIG. 3 are typical CSEM images illustrating observed microstructures of the control and test hardened ice cream products after hardening for 7 days (FIG. 3A) or 8 months (FIG. 3B). Direct observation under CSEM, as shown in the CSEM images, demonstrated that use of enzyme-modified egg yolk in hardened ice creams resulted in finer air bubbles, more uniform interfaces, finer fat globules, and significantly slower microstructural changes over the course of 8 months. In other words, hardened ice creams including enzyme-modified egg yolk exhibited stabler microstructures during freeze storage of the said frozen dessert.

### Example 4

### Soft Serve Ice Cream Formulations

An exemplary dessert product comprising a soft serve ice cream according to the present disclosure was prepared for testing. The ingredients used in preparing the test dessert product included whole milk, cream, sugar, water, and enzyme-modified egg yolk. Also prepared was a control dessert product comprising a soft serve ice cream lacking enzyme-modified egg yolk powder. The ingredients used in preparing the control dessert product included whole milk, cream, sugar, water, and unmodified rehydrated egg yolk powder, and whey protein concentrate. The ingredients were provided in the amounts indicated below in Table 4.

TABLE 4
Exemplary Soft Serve Ice Cream Formulations

| | Control | Test |
|---|---|---|
| Whole milk | 30.619% | 30.619% |
| Heavy cream (fat 40-43%) - portion 1 | 15.309% | 15.309% |
| Sugar | 14.332% | 14.332% |
| Coffee bean, whole - for extraction | 16.287% | 16.287% |
| Natural vanilla extract | 0.326% | 0.326% |
| Salt | 0.651% | 0.651% |
| Unmodified egg yolk | 7.166% | |
| Enzyme-modified egg yolk | | 7.166% |
| Heavy cream (fat 40-43%) - portion 2 | 15.309% | 15.309% |

An exemplary method for preparing dessert products based on the above formulations is summarized in FIG. 2 and is described elsewhere herein. Methods for preparing the test and control dessert products were identical so as to directly determine the influence of the enzyme-modified egg yolk ingredient versus unmodified egg yolk on the resulting dessert product.

### Example 5

### Evaluation of Soft Serve Ice Cream Formulations

In the case of the soft serve ice creams of Example 4, use of enzyme-modified egg yolk improved overrun and provided a smoother and creamier mouthfeel, better flavor release, and a less greasy profile, along with a fuller taste due to improved air incorporation and resultant microstructures.

Overrun of the benchtop soft serve ice cream samples was 44.0% for test samples made with enzyme-modified egg yolk. Under the same test conditions, overrun of the control samples made using unmodified egg yolk was 36.9%. Accordingly, use of enzyme-modified egg yolk improved ice cream overrun. The improved overrun may be due to the improved emulsification capability of the enzyme-modified egg yolk, which can reduce interfacial tension between the polar phase (e.g., water, sugar, salt) and the non-polar phase (e.g., fat and air). The reduced interfacial tension can help air more easily incorporated into the continuous phase and can form a more uniform and more stable foam system with more volume of air incorporated, thereby yielding a higher overrun.

Measured empirically, the melting rate of ice cream samples made with unmodified yolk was 0.82 g/min, and the melting rate of test soft serve ice cream product made with enzyme-modified yolk was 0.72 g/min. The test ice cream soft serve samples made using enzyme-modified egg yolk had a slower (lower) melting rate and took longer to completely melt down compared to the control. It took 115 min to completely melt 100 g of the test sample while only 105 min were needed to completely melt 100 g of the sample made with nonmodified yolk. These results suggested that use of enzyme-modified egg yolk in place of unmodified yolk can improve the melting rate of soft serve, which benefits key sensory attributes such as creaminess, smooth mouthfeel, palate coating, and overall flavor release.

The control and test soft serve ice cream products of Example 4 were also used for measurement of organoleptic attributes by a consumer sensory evaluation panel. The panel consisted of 8 consumer panelists. Panelists tasted the samples and provided feedback on organoleptic attributes. The feedback from the consumer panelists suggested that the test samples, made using enzyme-modified egg yolk, had a smoother mouthfeel and were slightly creamier, richer in body, and richer in overall flavor profile without wateriness as the samples melted.

### Example 6

### Soft Serve Ice Cream Formulations

An exemplary dessert product comprising a soft serve ice cream according to the present disclosure was prepared for testing. The ingredients used in preparing the test dessert product included whole milk, cream, sugar, water, and enzyme-modified egg yolk. Also prepared was a control dessert product comprising a soft serve ice cream containing the same usage level of standard non-enzyme-modified egg yolk powder. The ingredients used in preparing the control dessert product included whole milk, cream, sugar, water, and unmodified rehydrated egg yolk powder, and whey protein concentrate. The ingredients were provided in the amounts indicated below in Table 5.

TABLE 5
Exemplary Soft Serve Ice Cream Formulations

| | Control | Test |
|---|---|---|
| Whole milk | 39.528% | 39.528% |
| Whip cream (fat 33%) - portion 1 | 20.309% | 20.309% |
| Sugar | 14.920% | 14.920% |
| Coffee bean extract (Watkins) | 0.700% | 0.700% |
| Natural vanilla extract | 0.326% | 0.326% |
| Salt | 0651% | 0.651% |
| Unmodified egg yolk | 3.257% | |
| Enzyme-modified egg yolk | | 3.257% |
| Whip cream (fat 33%) - portion 2 | 20.309%% | 20.309% |

An exemplary method for preparing dessert products based on the above formulations is summarized in FIG. 2 and is described elsewhere herein. Methods for preparing the test and control dessert products were identical so as to directly determine the influence of the enzyme-modified egg yolk ingredient versus unmodified egg yolk on the resulting dessert product.

### Example 7

### Evaluation of Soft Serve Ice Cream Formulations

In the case of the soft serve ice creams of Example 6, use of enzyme-modified egg yolk again improved overrun and provided a smoother and creamier mouthfeel, better flavor release, and a less greasy profile, along with a fuller taste due to improved air incorporation and resultant microstructures. The test liquid mix showed noticeably improved air incorporation attributes when compared side-by-side with the control liquid mix.

Overrun of the soft serve ice cream on a commercial Vevor® machine was 48.79% for test samples made with enzyme-modified egg yolk. Under the same test conditions, overrun of the control samples made using unmodified egg yolk was only 22.41% and the control sample was noticeably denser after dispensation from the machine. Accordingly, use of enzyme-modified egg yolk significantly improved ice cream overrun when produced on commercial Vevor® ZM-A168 soft serve ice cream machine. The improved overrun may be due to the improved emulsification capability of the enzyme-modified egg yolk, which can reduce interfacial tension between the polar phase (e.g., water, sugar, salt) and the non-polar phase (e.g., fat and air). The reduced interfacial tension can help air to be more easily incorporated into the continuous phase and can from a more uniform and more stable foam system with a higher volume of incorporated air, thereby yielding a higher overrun.

Measured empirically, the melting rate of soft serve ice cream made with the commercial soft serve ice cream machine and with unmodified yolk was 0.8646 g/min, while the melting rate of test soft serve ice cream product made with enzyme-modified yolk was 0.7131 g/min. The test ice cream soft serve samples made using enzyme-modified egg yolk had a slower (lower) melting rate and took longer to completely melt down compared to the control soft serve ice cream samples. These results agreed well with those from benchtop tests and suggest that use of enzyme-modified egg yolk in place of unmodified yolk can improve the melting rate of soft serve, which benefits key sensory attributes such as creaminess, smooth mouthfeel, palate coating, and overall flavor release.

The melt viscosity of the control and test soft serve ice cream products of Example 6 was also measured using a LV Brookfield viscometer using the method as described in Example 8, spindle #63, 10 rpm and temperature at 2.1-2.4° C. The test soft serve ice cream, which was made on the Vevor® commercial soft serve ice cream machine and with enzyme-modified yolk powder, showed a melt viscosity of 224±25.92 cPs, while the control samples, which were produced using the same process and recipe except with non-enzyme-modified yolk, showed a melt viscosity of 186.67±13.06 cPs. The significantly higher melt viscosity of the test samples suggest that using enzyme modified yolk in place of regular/standard non-enzyme modified yolk results in a significantly fuller and creamier body and mouthfeel. This was confirmed with sensory evaluation by onsite operators during sample preparation.

### Example 8

### Exemplary Methods

Soft Serve Ice Cream Preparation. The soft serve ice cream machine was Vevor® (model ZM-A168) 3-head soft serve ice cream machine. Liquid ice cream mixes were prepared with the formulations of Examples 4 and 6 and according to the method summarized in FIG. 2, and the mixes were left to mature in a refrigerator for a minimum of 2 hours or overnight prior to being poured into soft serve ice cream machine hoppers. There were two 4.8 liter hoppers of the ZM-A168 Vevor® soft serve machine. The left hopper was used for the control mix, and the right hopper was used for the test mix sample. The mixes were processed following the operation manual of the Vevor® soft serve ice cream machine.

Overrun. Overrun was measured by comparing the weight of dessert product mix and dessert product in a fixed volume container. Overrun (in %) was calculated as:

$$Overrun = \frac{\begin{matrix}weight of liquid dessert product mix - \\ weight of finished product of same volume\end{matrix}}{weight of finished dessert product of same volume} \times 100.$$

To measure overrun, a 1000 ml marked container was filled with the complete dessert product mix to the 1000 ml mark and the weight (in grams) recorded as “weight of liquid dessert product mix.” After processing the dessert product mix to obtain the dessert product, but prior to packing the dessert product for hardening, the marked 1000 ml container was filled to the 100 ml mark and leveled off and the weight (in grams) recorded as “weight of finished dessert product of same volume.” The finished dessert product overrun was then be calculated using the above overrun equation.

Melting rate. Melting rate was objectively measured by placing a sample of a frozen dessert product weighing 100±1 g on a wire or mesh screen atop a funnel attached to a beaker or graduated cylinder. Hardened dessert samples were pre-conditioned to −12° C. prior to tests, while soft serve samples were drawn at −4.44° C. and not tempered. The dessert product was then placed in a controlled temperature chamber at, e.g., about 20±2° C. (RH≅50%). Periodically (e.g., every 1, 2, 3, 4, or 5 min) for a certain amount of time (e.g., 30 m, 45 m, 60 m, 120 m, or 180 m), the dripped volume of the dessert product was recorded. The time (min) was plotted against the dripped volume (mL) or weight (g), and the slope of the main melting event was taken as the melting rate.

Melting rate was also measured and rated by a panel of trained professionals (i.e., 6 ice cream professionals). In some aspects, a medium high melting rate corresponding to a score of about 8 by the trained professionals is desired. A higher melting rate suggests rapid meltdown of and flavor release by the product in the mouth (on the tongue), which can correspond to a less rich flavor and less creamy texture. A lower melting rate can cause a dull or dry mouthfeel and too slow a flavor release.

Melting viscosity. The viscosity of molten dessert product was determined by a rotational viscometer (e.g., a Brookfield LV viscometer). The temperature of the sample was fixed at 20±2° C. (RH≅50%) and the viscometer spindle (e.g., a #63 spindle) rotated at 20 rpm. Shear rate was at 10 rpm. Prior to testing, hardened ice cream samples were removed from frozen storage and tempered to 20±2° C. with periodic manual mixing. 500 mL of melted sample was added to a 500 mL glass beaker. Melted ice cream mixes were subjected to viscosity measurement under the conditions described above and with an elapsed time of 300 s.

Melting viscosity was also measured and rated by a panel of trained professionals (i.e., 6 ice cream professionals). In some aspects, a medium melting viscosity rating is desired. A lower melt viscosity rating suggests a dessert product that tastes watery on palate and has a poor texture, while a high melt viscosity can cause an undesirable coating on the palate and can result in a sticky and unclean mouthfeel.

The above specification and examples provide a complete description of the structure and use of illustrative embodiments. Although certain aspects have been described above with a certain degree of particularity, or with reference to one or more individual aspects, those skilled in the art could make numerous alterations to the disclosed aspects without departing from the scope of this disclosure. As such, the various illustrative aspects of the methods and systems are not intended to be limited to the particular forms disclosed. Rather, they include all modifications and alternatives falling within the scope of the claims, and aspects other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one aspect or may relate to several aspects.

1. A dessert product comprising one or more fats, one or more sweeteners, and enzyme-modified egg yolk comprising greater than or equal to 2% (w/w) free fatty acids.

2. (canceled)

3. The dessert product of claim 1, wherein the enzyme-modified egg yolk is a phospholipase-modified egg yolk, a hydrolyzed egg yolk, or a combination thereof.

4. The dessert product of claim 1, further comprising one or more additives, water, a protein source, or a combination thereof.

5. The dessert product of claim 1, wherein the dessert product is hard frozen ice cream, soft serve ice cream, frozen yogurt, sorbet, sherbet, or custard.

6. The dessert product of claim 1, wherein the dessert product comprises 0.5-18% (w/w) of the one or more fats, 10-28% (w/w) of the one or more sweeteners, and 0.1-5% (w/w) of the enzyme-modified egg yolk, based on the total weight of the dessert product.

7. The dessert product of claim 1, wherein the one or more fats comprise whole milk, skim milk, condensed milk, evaporated milk, anhydrous milk fat, cream, butter, butterfat, whey, milk solids non-fat, or a combination thereof.

8. The dessert product of claim 1, wherein the one or more sweeteners comprise sucrose, glucose, dextrose, syrups, artificial sweeteners, or a combination thereof.

9. The dessert product of claim 1, wherein the dessert product comprises whole milk, cream, sucrose, water, a protein source, and enzyme-modified egg yolk.

10. The dessert product of claim 1, wherein the dessert product exhibits an overrun of 30-60%.

11. The dessert product of claim 1, wherein the dessert product exhibits:
a melt rate after frozen storage that is significantly lower than a melt rate of a dessert product comprising an unmodified egg yolk; and/or
a mouthfeel after frozen storage that is significantly improved compared to a mouthfeel of a dessert product comprising an unmodified egg yolk.

12. (canceled)

13. The dessert product of claim 1, wherein the enzyme-modified egg yolk is an emulsifier configured to stabilize microstructures during frozen storage of the dessert product.

14. A method of producing a dessert product, comprising:
treating egg yolk with a phospholipase to hydrolyze the egg yolk phospholipids and yield an enzyme-modified egg yolk comprising greater than or equal to 2% (w/w) free fatty acids; and
blending into a homogenous liquid one or more fats, one or more sweeteners, and the enzyme-modified egg yolk.

15. The method of claim 14, further comprising deactivating the phospholipase after the egg yolk comprises greater than or equal to 2% (w/w) free fatty acids to form the enzyme-modified egg yolk comprising greater than or equal to 2% (w/w) free fatty acids.

16. (canceled)

17. The method of claim 14, further comprising refrigerating the homogenous liquid for at least 8 hours at a temperature of less than or equal to 4° C.

18. The method of claim 14, further comprising processing the homogenous liquid using a continuous freezer equipped with a heat exchanger.

19. The method of claim 14, further comprising spray-drying or freezing the enzyme-modified egg yolk prior to blending the enzyme-modified egg yolk into the homogenous liquid.

20. The method of claim 14, further comprising blending one or more additives, a protein source, or a combination thereof into the homogenous liquid.

21. The method of claim 14, wherein the dessert product is hard frozen ice cream, soft serve ice cream, frozen yogurt, sorbet, sherbet, or custard.

22. The method of claim 14, wherein the dessert product comprises 0.5 to 18% (w/w) of the one or more fats and 10-28% (w/w) of the one or more sweeteners, and 0.1-5% (w/w) of the enzyme-modified egg yolk, based on the total weight of the dessert product.

23. The method of claim 14, further comprising storing the dessert product at less than −18° C. for two or more months.
